(19) United States
(12) Patent Application Publication
(10) Pub. No.: US 2005/0108562 A1
(43) Pub. Date: May 19, 2005

(54) Technique for detecting executable malicious code using a combination of static and dynamic analyses

(76) Inventors: Roger I. Khazan, Somerville, MA (US); Jesse C. Rabek, Boston, MA (US); Scott M. Lewandowski, Reading, MA (US); Robert K. Cunningham, Lexington, MA (US)

Correspondence Address: Patent Group;Choate, Hall & Stewart, Exchange Place, 53 State Street, Boston, MA, 02109-2804, US

(21) Appl. No.: 10/464,828

(22) Filed: Jun. 18, 2003

(51) Int. Cl. G06F 11/30

(52) U.S. Cl. 713/200

(57) ABSTRACT

Described are techniques used for automatic detection of malicious code by verifying that an application executes in accordance with a model defined using calls to a predetermined set of targets, such as external routines. A model is constructed using a static analysis of a binary form of the application, and is comprised of a list of calls to targets, their invocation and target locations, and possibly other call-related information. When the application is executed, dynamic analysis is used to intercept calls to targets and verify them against the model. The verification may involve comparing the invocation and target location, as well as other call-related information, available at the time of call interception to the corresponding information identified by static analysis. A failed verification determines that the application includes malicious code. As an option, once detected, the malicious code may be allowed to execute to gather information about its behavior.

### STATEMENT OF GOVERNMENT INTEREST

The invention was made with Government support under contract No. F19628-00-C-0002 by the Department of the Air Force. The Government has certain rights in the invention.

### BACKGROUND

1. Technical Field

This application generally relates to computer systems, and more particularly to a computer program that executes in a computer system.

2. Description of Related Art

Computer systems may be used in performing a variety of different tasks and operations. As known in the art, a computer system may execute machine instructions to perform a task or operation. A software application is an example of a machine executable program that includes machine instructions which are loaded into memory and executed by a processor in the computer system. A computer system may execute machine instructions referred to herein as malicious code (MC). MC may be characterized as machine instructions which, when executed, perform an unauthorized function or task that may be destructive, disruptive, or otherwise cause problems within the computer system upon which it is executed. Examples of MC include, for example, a computer virus, a worm, a trojan application, and the like.

MC can take any one or more of a variety of different forms. For example, MC may be injected into a software application. Injection may be characterized as a process by which MC is copied into the address space of an application or process in memory without modifying the binary of the application on disk. For example, MC may be injected into an application's address space by exploiting a buffer overflow vulnerability contained in the application. It should be noted that injection techniques, and other types of MC, are known in the art and described, for example, in the Virus Bulletin (http://www.virusbtn.com) and in “Attacking Malicious Code: A report to the Infosec Research Council,” by G. McGraw and G. Morrisett (IEEE Software, pp. 33-41, 2000. (http://www.cigital.com/˜gem/malcode.pdf).

MC may also be embedded within a software application on disk in which case the MC appears as part of the application's code. Embedded MC may be classified as simple, dynamically generated, or obfuscated. Dynamically generated MC may be characterized as MC that is generated during application execution. For example, the MC may be in a compressed form included as part of the software application. When the software application is executed, the MC is decompressed and then executed. Obfuscated MC may be characterized as MC which tries to disguise the actual operation or task in an attempt to hide its malicious intention. Obfuscated MC may, for example, perform complex address calculations when computing a target address of an execution transfer instruction at run time. Simple MC may be characterized as MC that is embedded, but which is not one included in the other foregoing categories. Simple MC may be characterized as code that appears as “straight-forward” or typical compiler-generated code.

There is a wide variety of known approaches used in detecting the foregoing types of MC. The approaches may be placed into two general categories referred to herein as misuse detection approaches and anomaly detection approaches. Misuse detection approaches generally look for known indications of MC such as, for example, known static code patterns, such as signatures of simple MC, or known run time behavior, such as execution of a particular series of instructions. Anomaly detection approaches use a model or definition of what is expected or normal with respect to a particular application and then look for deviations from this model.

Existing techniques based on the foregoing approaches used in MC detection have drawbacks. One problem is that existing misuse detection techniques are based only on the known static features and/or dynamic behaviors of existing MC. These techniques may miss, for example, slight variations of known MC and new, previously unseen, instances of MC. Another problem relates to models, and techniques for generating them, that may be used in connection with anomaly detection approaches. Approaches in which humans generate and construct a model of an application may be inappropriate and impractical because they are time consuming and may be error prone due to the level of detail that may be required to have an accurate and usable model. Some existing anomaly detection techniques create models of normal behavior of a particular application based on observing sequences of system calls executed at run time as part of a learning phase. When the learning phase is completed, anomaly detection may be performed by continuing to monitor the application's executions looking for run time deviations from the learned behavior. With such techniques, false positives may result, for example, due to the limited amount of behavior observed during a learning phase. Unlearned behavior of an application observed during an anomaly detection phase, but not during the learning phase, results in false positives. Thus, from the conception of the model, there are anticipated failures. Additionally, statistical based models constructed from statistical measurements of static features and/or dynamic behavior of an application may be used. Statistical models generally include a detection threshold which adjusts the amount of false positives and/or false negatives. Finally, models can be constructed by static analysis of software applications but such approaches have not been practical. Some of these models are too “heavy weight” having excessive details about possible applications' behaviors so that they are not applicable to real-world software applications, and/or cannot be constructed, and/or used within acceptable overhead limits. In contrast, other existing models are too “light weight” having not enough detail so MC can easily bypass detection. Similar problems may apply to the models constructed by methods other than static analysis, such as by observing application's behavior.

Thus, it may be desirable to have an efficient technique for MC detection that is applicable to real-world software applications and is able to accurately detect known and unknown MC prior to executing the MC. It may be especially desirable to have such techniques for detecting challenging classes of MC, such as injected, dynamically generated, and obfuscated. Additionally, it may be desirable that the technique be able to, in addition to detecting presence of MC, identify which code portions within the applications correspond to the MC. It may also be desirable that the technique be useful in analysis MC, for example, to gather information about MC.

### SUMMARY OF THE INVENTION

In accordance with one aspect of the invention is a method for detecting malicious code comprising: performing static analysis of an application prior to execution of the application identifying any invocations of at least one predetermined target routine; determining, prior to executing said at least one predetermined target routine during execution of the application, whether a run time invocation of the at least one predetermined target routine has been identified by said static analysis as being invoked from a predetermined location in said application; and if the run time invocation of the at least one predetermined target routine has not been identified from a predetermined location by said static analysis, determining that the application includes malicious code.

In accordance with another aspect of the invention is a method for detecting malicious code comprising: determining, prior to executing at least one predetermined target routine during execution of the application, whether a run time invocation of the at least one predetermined target routine is identified by a model as being invoked from a predetermined location in said application, said model identifying locations within said application from which invocations of the at least one predetermined target routine occur; and if the run time invocation of the at least one predetermined target routine has not been identified from a predetermined location by said model, determining that the application includes malicious code.

In accordance with yet another aspect of the invention is a method for detecting malicious code comprising: obtaining static analysis information of an application identifying any invocations of at least one predetermined target routine; determining, prior to executing said at least one predetermined target routine during execution of the application, whether a run time invocation of the at least one predetermined target routine has been identified by said static analysis information as being invoked from a predetermined location in said application; and if the run time invocation of the at least one predetermined target routine has not been identified from a predetermined location by said static analysis information, determining that the application includes malicious code.

In accordance with another aspect of the invention is a computer program product that detects malicious code comprising: executable code that performs static analysis of an application prior to execution of the application identifying any invocations of at least one predetermined target routine; executable code that determines, prior to executing said at least one predetermined target routine during execution of the application, whether a run time invocation of the at least one predetermined target routine has been identified by said static analysis as being invoked from a predetermined location in said application; and executable code that, if the run time invocation of the at least one predetermined target routine has not been identified from a predetermined location by said static analysis, determines that the application includes malicious code.

In accordance with another aspect of the invention is a computer program product that detects malicious code comprising: executable code that determines, prior to executing at least one predetermined target routine during execution of the application, whether a run time invocation of the at least one predetermined target routine is identified by a model as being invoked from a predetermined location in said application, said model identifying locations within said application from which invocations of the at least one predetermined target routine occur; and executable code that, if the run time invocation of the at least one predetermined target routine has not been identified from a predetermined location by said model, determines that the application includes malicious code.

In accordance with yet another aspect of the invention is a computer program product that detects malicious code comprising: executable code that obtains static analysis information of an application identifying any invocations of at least one predetermined target routine; executable code that determines, prior to executing said at least one predetermined target routine during execution of the application, whether a run time invocation of the at least one predetermined target routine has been identified by said static analysis information as being invoked from a predetermined location in said application; and executable code that, if the run time invocation of the at least one predetermined target routine has not been identified from a predetermined location by said static analysis information, determines that the application includes malicious code.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment of a computer system according to the present invention;

FIG. 2 is an example of an embodiment of a data storage system of the computer system of FIG. 1;

FIG. 3 is an example of an embodiment of components that may be included in a host system of the computer system of FIG. 1;

FIG. 4A is an example of an embodiment of components that may be included in a host computer of FIG. 1;

FIG. 4B is a flowchart of processing steps that may be performed in an embodiment using the components of FIG. 4A.

FIG. 5 is an example of routines that may be invoked in an embodiment of the dynamic analyzer of FIG. 4A;

FIG. 6 is an example of a representation of the address space of an application and associated libraries loaded into memory, possibly in a suspended state;

FIG. 7 is an example of a logical flow of control between functions at run time to intercept calls to the predetermined functions or routines being monitored as part of dynamic analysis;

FIG. 8 is a flowchart of method steps of one embodiment for instrumenting functions or routines;

FIG. 9 is a flowchart of method steps of one embodiment summarizing run time processing related to monitoring as performed by the dynamic analyzer; and

FIGS. 10, 11 and 12 are examples of embodiments of data structures that may be used in storing the target locations and corresponding invocation locations.

### DETAILED DESCRIPTION OF EMBODIMENT(S)

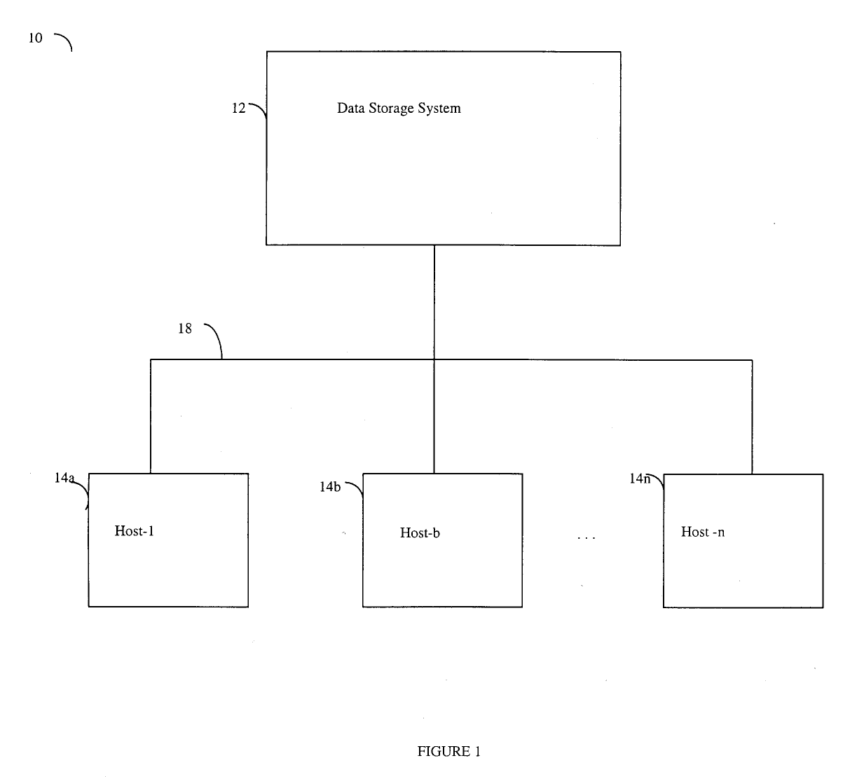

Referring now to FIG. 1, shown is an example of an embodiment of a computer system according to the present invention. The computer system 10 includes a data storage system 12 connected to host systems 14a-14n through communication medium 18. In this embodiment of the computer system 10, the N hosts 14a-14n may access the data storage system 12, for example, in performing input/output (I/O) operations or data requests. The communication medium 18 may be any one of a variety of networks or other type of communication connections as known to those skilled in the art. The communication medium 18 may be a network connection, bus, and/or other type of data link, such as a hardwire, wireless, or other connection known in the art. For example, the communication medium 18 may be the Internet, an intranet, network or other connection(s) by which the host systems 14a-14n may access and communicate with the data storage system 12, and may also communicate with others included in the computer system 10.

Each of the host systems 14a-14n and the data storage system 12 included in the computer system 10 may be connected to the communication medium 18 by any one of a variety of connections as may be provided and supported in accordance with the type of communication medium 18.

It should be noted that the particulars of the hardware and software included in each of the host systems 14a-14n, as well as those components that may be included in the data storage system 12, are described herein in more detail, and may vary with each particular embodiment. Each of the host computers 14a-14n may all be located at the same physical site, or, alternatively, may also be located in different physical locations. Examples of the communication medium that may be used to provide the different types of connections between the host computer systems and the data storage system of the computer system 10 may use a variety of different communication protocols such as SCSI, ESCON, Fibre Channel, or GIGE (Gigabit Ethernet), and the like. Some or all of the connections by which the hosts and data storage system 12 may be connected to the communication medium 18 may pass through other communication devices, such as a Connectrix or other switching equipment that may exist such as a phone line, a repeater, a multiplexer or even a satellite.

Each of the host computer systems may perform different types of data operations in accordance with different types of tasks. In the embodiment of FIG. 1, any one of the host computers 14a-14n may issue a data request to the data storage system 12 to perform a data operation, such as a read or a write operation.

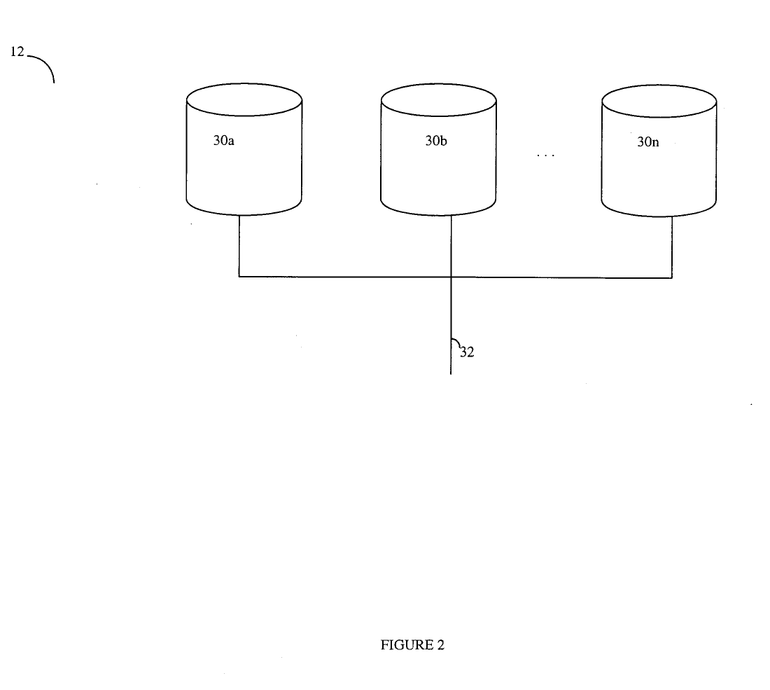

Referring now to FIG. 2, shown is an example of an embodiment of a data storage system 12 that may be included in the computer system 10 of FIG. 1. The data storage system 12 in this example may include a plurality of data storage devices 30a through 30n. The data storage devices 30a through 30n may communicate with components external to the data storage system 12 using communication medium 32. Each of the data storage devices may be accessible to the hosts 14a through 14n using an interface connection between the communication medium 18 previously described in connection with the computer system 10 and the communication medium 32. It should be noted that a communication medium 32 may be any one of a variety of different types of connections and interfaces used to facilitate communication between communication medium 18 and each of the data storage devices 30a through 30n.

The data storage system 12 may include any number and type of data storage devices. For example, the data storage system may include a single device, such as a disk drive, as well as a plurality of devices in a more complex configuration, such as with a storage area network and the like. Data may be stored, for example, on magnetic, optical, or silicon-based media. The particular arrangement and configuration of a data storage system may vary in accordance with the parameters and requirements associated with each embodiment.

Each of the data storage devices 30a through 30n may be characterized as a resource included in an embodiment of the computer system 10 to provide storage services for the host computer systems 14a through 14n. The devices 30a through 30n may be accessed using any one of a variety of different techniques. In one embodiment, the host systems may access the data storage devices 30a through 30n using logical device names or logical volumes. The logical volumes may or may not correspond to the actual data storage devices. For example, one or more logical volumes may reside on a single physical data storage device such as 30a. Data in a single data storage device may be accessed by one or more hosts allowing the hosts to share data residing therein.

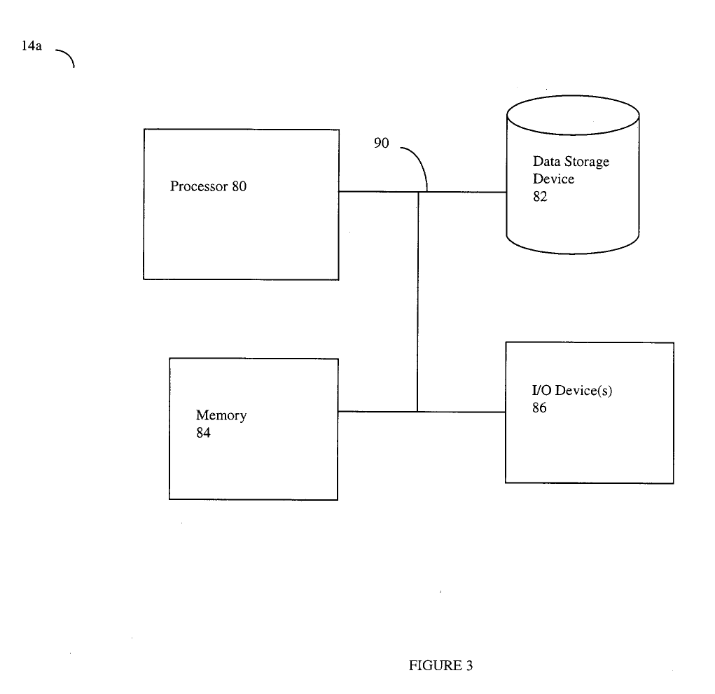

Referring now to FIG. 3, shown is an example of an embodiment of a host or user system 14a. It should be noted that although a particular configuration of a host system is described herein, other host systems 14b-14n may also be similarly configured. Additionally, it should be noted that each host system 14a-14n may have any one of a variety of different configurations including different hardware and/or software components. Included in this embodiment of the host system 14a is a processor 80, a memory, 84, one or more I/O devices 86 and one or more data storage devices 82 that may be accessed locally within the particular host system. Each of the foregoing may communicate using a bus or other communication medium 90. Each of the foregoing components may be any one or more of a variety of different types in accordance with the particular host system 14a.

Each of the processors included in the host computer systems 14a-14n may be any one of a variety of commercially available single or multi-processor system, such as embedded Xscale processor, an Intel-compatible x86 processor, an IBM mainframe or other type of commercially available processor, able to support incoming traffic in accordance with each particular embodiment and application.

Computer instructions may be executed by the processor 80 to perform a variety of different operations. As known in the art, executable code may be produced, for example, using a linker, a language processor, and other tools that may vary in accordance with each embodiment. Computer instructions and data may also be stored on a data storage device 82, ROM, or other form of media or storage. The instructions may be loaded into memory 84 and executed by processor 80 to perform a particular task.

In one embodiment, an operating system, such as the Windows operating system by Microsoft Corporation, may reside and be executed on one or more of the host computer systems included in the computer system 10 of FIG. 1.

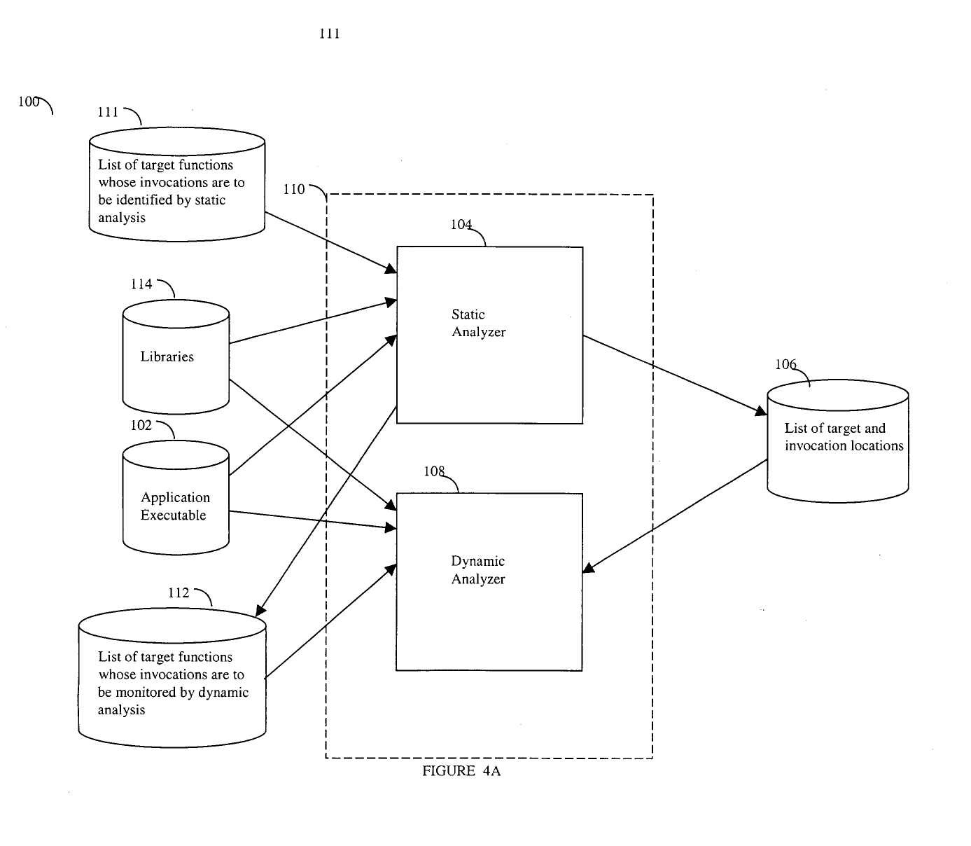

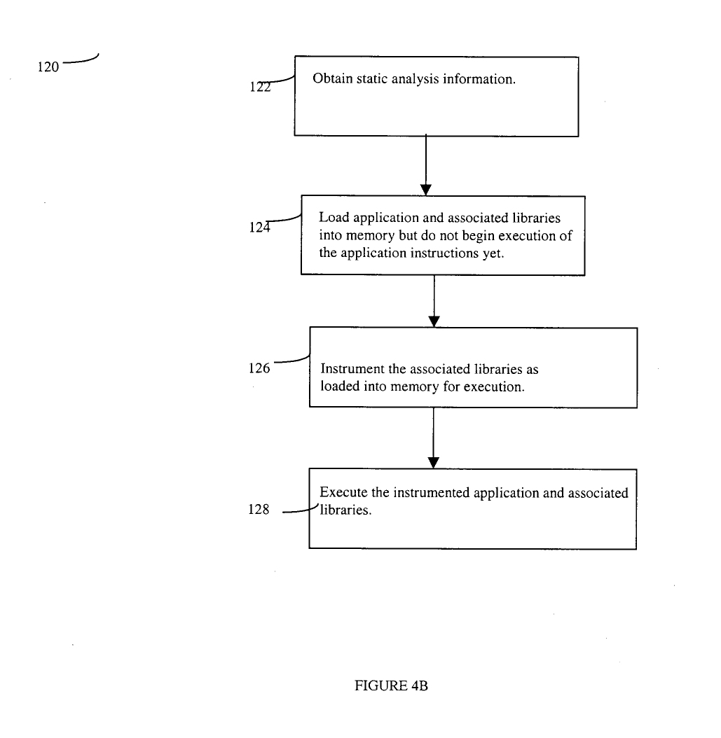

Referring now to FIG. 4A, shown is an example of an embodiment of components that may reside and be executed on one or more of the host computer systems included in the computer system 10 of FIG. 1. The components 100 in this embodiment include an application executable 102, one or more libraries, such as dynamic link libraries (DLLs) 114, a malicious code (MC) detection system 110, the list of targets and invocation locations 106, a list of target functions whose invocations are to be identified by static analysis 111, and a list of target functions whose invocations are to be monitored by dynamic analysis 112. The MC detection system 110 includes a static analyzer 104 and a dynamic analyzer 108. The application executable 102 may be characterized as a binary file or machine executable program as may be produced, for example, by compiling and linking. In order to execute the application executable 102 from this point, the application executable may be loaded in memory, for example, as by a loader. Subsequently, the instructions of the application executable 102 may be executed by one or more processors of the host computer.

It should be noted that a DLL as used herein refers to a particular type of library as used in the Windows operating system by Microsoft Corporation. Other embodiments may use other terms and names in describing other libraries that vary with the particular software of the embodiment. Also, as used herein, the terms functions and routines are used interchangeably.

In this embodiment, prior to executing the application executable 102, an analysis may be performed by the static analyzer 104 to examine and identify calls or invocations made from the application executable 102 to a predetermined set of target functions or routines. An embodiment may also identify additional information about these functions, such as, for example, particular locations within the application from which the calls to these functions are made, parameter number and type information for each call, the values that some of these parameters take at run-time, and the like. For example, in one embodiment, it may be determined that the target function calls to be identified are those that are external to the application 102, such as those calls that are made to system functions. These functions may represent the set of Win32 Application Programming Interfaces (APIs) as known to those of ordinary skill in the art in connection with the Windows operating system by Microsoft Corporation.

Static analysis processing as described herein may be characterized as identifying information about code by static examination of code without execution. Part of the static analysis processing described herein identifies, within the binary code of an application, the calls that are made to a set of predetermined target functions, and information related to these calls. The calls identified do not include those whose target addresses are computed at run time. Rather, the calls identified are those which may be determined by examining the binary code for known instructions making calls where the static analyzer is able to identify the target functions being called as one of those of interest.

The list of target functions whose invocations are to be identified by static analysis 111 may be optionally specified in an embodiment. The particular target function(s) whose invocations are to be identified by the static analyzer may also be embedded within the static analyzer in an embodiment. Further, in a case when target functions are external to the application executable, an embodiment may identify all external function calls, a subset of external function calls, such as the Win32 API calls, or another predetermined set. For example, an embodiment may choose to identify calls or invocations made from the application executable corresponding to the interface between the application and the operating system. In other words, the static analyzer 104 may perform an analysis of the application to determine what calls are made from the application to a defined set of one or more operating system functions.

An embodiment may examine the application executable 102 using any one of a variety of different techniques to look for any calls to one or more predetermined functions or routines. The static analyzer 104 may examine the binary code of the application executable 102 to look for predetermined call instructions, or other type of transfer instructions associated with calls to target functions. One embodiment uses the IDA Pro Disassembler by DataRescue (http://www.datarescue.com/idabase/) and Perl scripts in performing the static analysis of the application executable 102 to obtain the list of targets and invocation locations 106 associated with the invocations of the Win32 API functions, which is described in more detail elsewhere herein.

The particular type of target calls and their form may vary in accordance with each embodiment. For example, in one embodiment, the binary representation of the application executable 102 may include a jump instruction, a call instruction, or other types of instructions transferring control from the application as may be the case for various routines being monitored.

It should be noted that the particular format of the instructions included in the application executable 102 may vary in accordance with each embodiment. Static analyzer 104 may have a list or other data structure of one or more instructions signifying a target call that may be included in the application executable 102. In this embodiment, the static analyzer 104 searches the binary file 102 for machine dependant instructions which vary in accordance with the particular instruction set as well as the particular file format of the application executable 102. For example, in one embodiment, the application executable 102 may have a Win32 portable executable (PE) binary file format. As known to those of ordinary skill in the art, the Win32 PE binary file may be characterized as an extension of the Common Object File Format (COFF). Static analyzer 104 is able to identify the call instructions and other instructions that may be included in application executable 102 that may vary with the particular instructions as well as the format of the different application executable file types 102 that may be analyzed.

An embodiment of the static analyzer 104 may also look for one or more different types of calls including, for example, direct calls and indirect calls. In one embodiment, the calls determined by the static analyzer 104 are the Win32 APIs which are predetermined subset of externally called functions or routines. External calls that are detected by the static analyzer may, for example, have the form of a direct call instruction, such as CALL XXX, where XXX is the API being invoked as defined in the import address table of the PE binary file. Indirect calls may also be identified during static analysis. In one embodiment, an indirect call may be of the form:
MOV REGn, A; Move/load the address of API A to REGn
. . . ; Instructions that do not modify REGn
CALL REGn; Invoke the API A or,
GetProcAddress (API_A); Get the address of API_A and store in register eax
. . . ; Instructions that do not modify eax
MOV REGn, eax; Store the address of API_A in REGn
. . . ; Instructions that do not modify REGn
Call REGn; Invoke API_A
   The foregoing are just some examples of the forms of direct and indirect calls or invocations that an embodiment may identify, for one example operating system and one example hardware platform. To facilitate such identifications, an embodiment may employ forward and/or backward slicing static analysis techniques.

An embodiment of a static analyzer 104 may look for any one or more of the foregoing calls being analyzed by this system in accordance with the types of calls and associated formats that are supported by the application executable and associated instruction sets.

As part of static analysis, an embodiment of the static analyzer may also identify additional information about the identified calls, such as about their parameter number, typing, and run-time values, as well as about their return addresses. This additional information may be used in the run time verification processing performed by the dynamic analyzer, described elsewhere herein. It should be noted that, as known to those of ordinary skill in the art, arguments may obtain their values at run time. As such, static analysis may not be able to identify all parameter attributes or the same attribute(s) for each parameter. An embodiment of the static analyzer may perform whatever degree of parameter analysis is possible in accordance with the particular parameters being analyzed. This parameter information and other types of information may be stored with the corresponding target function call in the list of targets and invocation locations 106.

As an output, the static analyzer 104 produces a list of targets and invocation locations 106, as related to the identified function calls. As described elsewhere herein, the analyzer 104 may also output associated parameter information and other information used in the later run time verification. The list 106 includes a list of invocation locations within the application executable 102 from where calls to particular target functions are made. Additionally, associated with each of these invocation locations is a reference to the target function. For example, if the application executable 102 includes an invocation of a routine A from offset or address 10 in the main program, the list 106 includes an invocation location corresponding to offset 10 within the main program associated with a call to the external routine named A.

In addition to analyzing an application executable, the static analyzer 104 may analyze some or all libraries that may include routines or functions which are directly or indirectly invoked from the application executable 102. In other words, the application may include an external call to a function in a first library. This function may invoke another function in a different library. The static analyzer 104 may be used to perform static analysis on both of these libraries.

An embodiment may determine libraries or DLLs upon which to perform static analysis using any one or more of a variety of different techniques described herein. In one embodiment, the static analyzer may examine a portion of the application executable, such as the import address table, which indicates the libraries used. Additionally, libraries may be loaded dynamically during execution of the application using, for example, the LoadLibrary routine. The static analyzer may also examine the parameters of the LoadLibrary routine to determine additional libraries requiring static analysis. The foregoing may be used to perform static analysis on those libraries upon which the application is dependent. An embodiment may also perform static analysis on libraries specified in other ways. For example, static analysis may be performed on a select group of libraries that may be used by the application and possibly others. The libraries may be included in a particular directory, location on a device, and the like. An embodiment may also not perform all the needed static analysis of all libraries used by an application prior to executing the application. In this instance, static analysis, or a form of local static analysis, may be performed dynamically during execution of the application. This may not be the preferred processing mode. The dynamic static analysis or performing of a form of static analysis during execution of the application is described elsewhere herein in more detail.

Although a static analyzer 104 has been used in connection with obtaining a list of targets and invocation locations 106, and any associated static analysis information such as parameter information, any one of a variety of techniques may be used in obtaining this list, prior to actually loading and executing the application executable 102 as described elsewhere herein in more detail. An embodiment may also determine the list, or some portion of it, at some point after the application executable 102 is produced, but prior to invocation of the application for execution. Also, as mentioned elsewhere herein, this may be done during execution of the application as described in more detail elsewhere herein. Additionally, an embodiment may produce a list of targets and invocation locations, or some portion of it, using other tools and/or manual techniques than as described herein. For example, the list associated with a particular application may be obtained from a remote host or data storage system, or may be distributed together with the particular application.

As described herein, the static analyzer performs static analysis of the application executable 102 and possibly one or more libraries 114 to identify calls to target functions. At a later point in time during execution of the application, as part of dynamic analysis, calls made to target functions by the application and/or its libraries are monitored. As part of this monitoring, verification can be done, which may rely on the static analysis information obtained as part of static analysis.

The techniques described herein can be used to distinguish between normal or expected behavior of code and the behavior produced by MC. The technique described herein creates an application model using the information obtained from the static analyzer 104. It then uses this model, defined in terms of the invocation and target locations of function calls and optionally other call information such as parameter information identified prior to execution, to verify the run time behavior of the application executable 102. If the run time behavior deviates from the application model, it is determined that the application executable has executed MC.

Dynamic analysis may be characterized as analysis performed of the run time behavior of code. Dynamic analysis techniques are described herein and used in connection with performing run time monitoring and verification processing for the purpose of detecting and analyzing MC.

As described in more detail elsewhere herein, the dynamic analyzer 108 facilitates execution of the application executable 102 and performs run time validation of the application's run time behavior characterized by the target function calls being monitored. Normal behavior, or non-MC behavior, is associated with particular target function calls identified by the static analyzer 104. Normal behavior may be characterized by the use of the target function calls whose locations were identified during the pre-processing step by the static analyzer 104. Validation may be performed at run time by actually executing the application executable 102 to ensure that the target function calls that are made at run time match the information obtained by the static analyzer 104 using the invocation location and target location pairs. If there are any deviations detected during the execution of the application executable 102, it is determined that the application executable 102 includes MC.

It should be noted that an embodiment may detect MC in accordance with one or more levels of run time verification. For example, in one embodiment, a first level of run time verification may be performed of the target function calls being monitored using only the invocation and target location information. An embodiment may also perform a second level of run time verification using the invocation and target location information as well as other run time information also identified by static analysis, such as the parameter information. An embodiment may also use interface options, command line options or other techniques in connection with specifying any such different levels that may be included in an embodiment for MC detection as well as MC analysis, which is described elsewhere herein. An embodiment may also choose different levels of verification while monitoring and verifying a particular application execution, depending on various considerations, such as the type of the application and the type of target function calls, as well as performance and any other considerations. Alternatively, an embodiment may not provide such leveling options.

It should be noted that the predetermined set of functions or routines whose invocations are to be monitored by dynamic analysis may be included in an optionally specified list of target functions whose invocations are to be monitored 112. Techniques are described elsewhere herein in connection with identifying functions to be monitored.

An embodiment of the static analyzer 104, in addition to performing its primary tasks described elsewhere herein, may also output a portion of the list of target functions to be monitored. As the static analyzer 104 identifies a call to a particular target function in the application 102, the static analyzer 104 may also add the function to the list 112 of target functions whose invocations are to be monitored at run time. In one embodiment, the list 112 may be a superset of those identified by the static analyzer. Other embodiments may use other techniques described elsewhere herein in connection with determining the list 112, or portions thereof.

Additionally, the target functions whose invocations are to be monitored, may also be specified using different techniques than as a list 112, which is an explicit input to the dynamic analyzer 108. For example, the particular target functions, whose invocations are being monitored, or a portion of these functions, may be embedded within the dynamic analyzer itself rather than being an explicit input. An embodiment may also choose to monitor all API calls made by an application.

It should be noted that one or more of the components included in FIG. 4A may also be stored in the data storage system. The dynamic analyzer 108 and the static analyzer 104 may be executed on any one of a variety of different computer processor or processors of a host system, for example, as described elsewhere herein in more detail. The foregoing dynamic analyzer 108 and static analyzer 104 may also be produced using any one of a variety of different techniques or a combination thereof. For example, in one embodiment, one or both of these may be generated using a programming language, such as the C++ programming language and a compiler, or other translator on a Windows 2000 operating system with an Intel-based processor. The data and the components included in 100 are described in more detail in following paragraphs and in connection with other figures.

Referring now to FIG. 4B, shown is a flowchart 120 of processing steps that may be performed in an embodiment using the components of 100 of FIG. 4A. The target functions are assumed to be external to the application. At step 122, the static analysis information, such as list of target locations and invocation locations is obtained as described elsewhere herein, for example, in connection with FIG. 4A. At step 124, the application being monitored and associated libraries are loaded into memory. However, the instructions of the application are not yet executed. The application state at this point may be characterized as suspended after it is loaded into memory. It should be noted that not all libraries may be loaded at this point since additional libraries may be loaded at run time, for example, using the LoadLibrary function. At step 126, the associated libraries, such as all operating system DLLs, are instrumented to intercept calls to a predetermined set of target functions at run time. The particular libraries instrumented may be determined, for example, in accordance with the list of external functions whose invocations are to be monitored 112, the external dependencies of the application 102, or other techniques. At step 128, the instrumented application and associated libraries are executed. As described in more detail in following paragraphs, the instrumentation facilitates monitoring of the application's executions as pertaining to the invocations of the external target functions.

It should be noted that in order to monitor external calls, an embodiment may instrument a set of DLLs or libraries that is a superset of those actually used by the application. This may be performed in order to detect MC that uses routines that are not used by the application itself. For example, in one embodiment all calls to operating system routines are being monitored. As part of the instrumenting process, all DLLs that include operating system routines may be instrumented independent of what DLLs the application is dependent or may use.

Generally, the instrumentation technique described in one embodiment herein modifies the memory loaded copy of the application and associated libraries to execute additional monitoring code. An embodiment may also utilize other techniques in connection with instrumentation. For example, an embodiment may rewrite instrumented DLLs onto a storage device, such as a disk, rather than modify memory loaded versions of the DLLs. These may not require creating the process in a suspended state since instrumentation may be performed before invocation of the application. In other words, one or more DLLs may be instrumented in which an instrumented version of the DLL may be stored on a storage device. This instrumentation may be performed, for example, when pre-processing is performed as described elsewhere herein in connection with static analysis, or either before or after that. The one or more DLLs that are instrumented and stored on disk may be determined based on particular DLL characteristics and/or usage characteristics. For example, an embodiment may instrument only security-critical DLLs on disk.

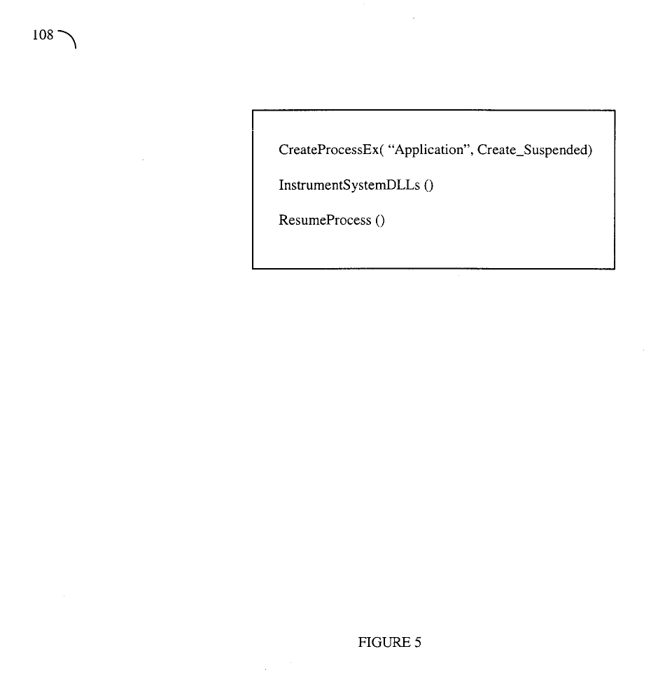

Referring now to FIG. 5, shown is an example of a pseudo code-like description of routines that may be included in the dynamic analyzer 108. In this example, the dynamic analyzer 108 includes a call to CreateProcessEx, a routine that creates a process loading the application and DLLs into memory placing the application in a suspended execution state. After executing the CreateProcessEx routine, the application 102 has been loaded, but it has not yet begun execution. CreateProcessEx performs the processing of step 124 of FIG. 4B. Control then returns to the dynamic analyzer 108 where the routine InstrumentSystemDLL is invoked. The routine InstrumentSystemDLL is described in more details in the following paragraphs and performs processing steps in connection with instrumenting code in order to monitor the application at run time, as described in connection with step 126 of FIG. 4B. After completion of the routine InstrumentSystemDLL, the application and memory loaded libraries executing in the application's address space have been instrumented and control proceeds with execution of the application with the ResumeProcess routine, as described in connection with step 128 of FIG. 4B.

In one embodiment, the InstrumentSystemDLL routine may be a thread that instruments all the operating system libraries, such as those associated with the Win32 APIs. As described elsewhere herein, an embodiment may use other techniques, such as analyzing the import address table and the like to determine which libraries are used by the application, and then instrument those libraries. By analyzing operating system libraries, routines which perform dynamic loading of other libraries, such as LoadLibrary and GetProcAddress, are also instrumented. Thus, at run time, if a call is made to LoadLibrary, for example, to load some library 114 at run time, this call is intercepted. If the embodiment has not previously instrumented this library, instrumentation may be dynamically performed at run time after the library is loaded but before any function exported by this library is executed. Additionally, any libraries used by this library that have not been instrumented may be instrumented at run time as well.

If at run-time, a call is made to a routine being monitored from a library or an application component for which static analysis has not been performed during the pre-processing step, static analysis may also be performed at run time. This static analysis may be of the complete library, or a portion of the library. In one embodiment, local static analysis may be performed for the call which is intercepted due to the instrumentation. Once the call is trapped or intercepted, the location from which the call instance has been made is determined. This location may be determined, for example, by examining the run time stack to obtain the return address of the caller. Using this address, an embodiment may examine, using the disk copy of the binary of the caller, the instruction prior to the return which should identify the intercepted call. It should be noted that an embodiment may examine the disk copy of the binary of the caller since certain types of MC, such as dynamically generated, may have mutated such that the binary in memory and the binary on disk are different. An embodiment may use the memory copy of the caller rather than the disk copy to detect, for example, an improper invocation if the MC is obfuscated MC. However, if the memory copy is used, an embodiment may not be able to detect certain types and occurrences of MC which are, for example, dynamically generated or injected at run-time. Similarly, at run time, an embodiment may also determine parameter and other information about a call by examining the disk copy of the binary of the routine and compare that to the run time information for the particular run time invocation. An embodiment may use caching techniques when performing local static analysis to reuse the results of the static analysis performed during run time on subsequent calls to the same target routine from the same location within the application or its libraries.

In the example described herein, Win32 API functions are instrumented for the purpose of being intercepted although an embodiment may monitor or intercept any one or more different functions or routines. Any one of a wide variety of different techniques may be used in connection with instrumenting the application 102 and any necessary libraries. In one embodiment, the Detours package as provided by Microsoft Research may be used in connection with instrumenting Win32 functions for use on Intel x86 machines.

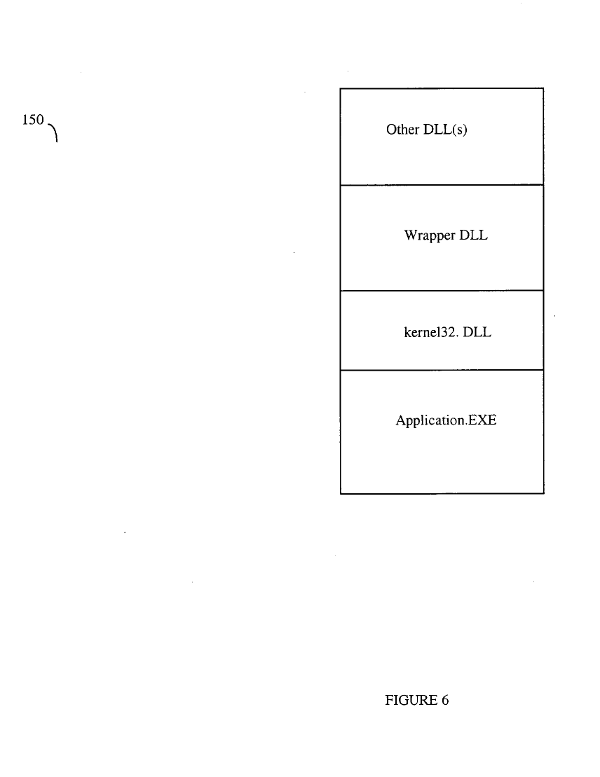

Referring now to FIG. 6, shown is an example of a representation of the run time user address space 150 of the application 102. In this example, the application executable may be located in the first portion of its address space. Additionally loaded in the address space of the application is the kernel32 DLL and the Wrappers DLL. The kernel32 DLL in this example may include target functions or routines being invoked from the application executable. The kernel32 DLL is included as a library or DLL with the underlying Microsoft Windows operating system which, in this example, includes a portion of the Win32 API functions. As used herein in this embodiment, Wrappers is a library, such as a DLL, that may be produced using the Detours package described elsewhere herein, used in intercepting arbitrary Win32 API calls. As described elsewhere herein, the Wrappers DLL includes user-supplied code segments in wrapper or stub functions. The wrapper or stub functions may be built using functionality included in the Detours package. The user-supplied code segments may include, for example, pre-monitoring and post-monitoring code and other run time monitoring and/or verification code as described elsewhere herein. Additionally, one or more other DLLs or libraries may be used by the application such as, for example, a customized library that may be loaded initially and/or dynamically during execution of the application.

It should be noted that the particular components, for example, one or more libraries, shared objects, and the like, loaded into the address space may vary in accordance with the target routines used by the application. These may be identified, for example, as DLLs imported by the application. Additionally, the application may also cause a library to be dynamically loaded during execution, for example, by using LoadLibrary routine.

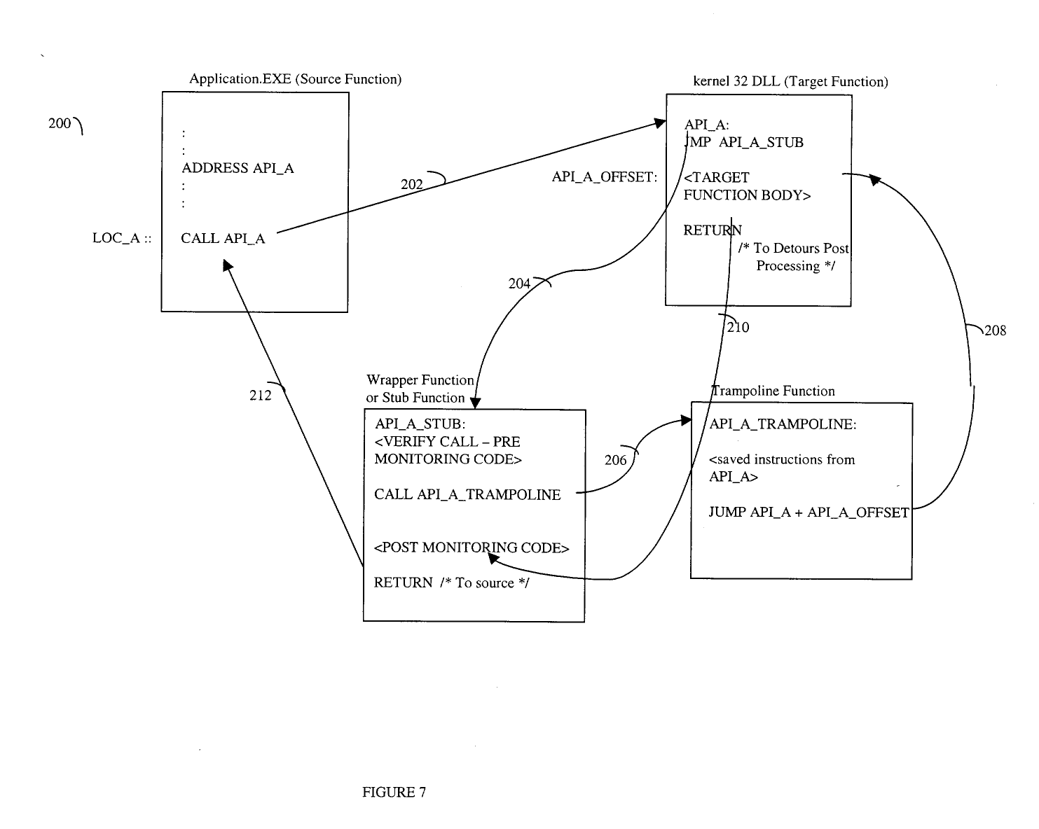

Referring now to FIG. 7, shown is the logical flow of control in one embodiment when an external target function, such as a Win32 API function, is invoked at run time from the application using a call instruction. The external call is intercepted using the instrumentation techniques described herein. Representation 200 traces through the flow of control that occurs during execution of the application 102, for example, as described in connection with step 128 of FIG. 4B. The representation 200 includes a source function of application.exe, a target function within the kernel32 DLL that is invoked from the source function, a stub function or wrapper function and a trampoline function. Source function in this example is located in the application.exe and is the function from which the target function is invoked. The wrapper function is used in connection with performing run time monitoring and verification of the intercepted call to the target function and uses the trampoline function as an auxiliary function.

What will now be described is the flow of control represented in connection with the arrows between each of the different functions in the representation 200. Beginning with the source function of the application's binary, a call is made to the target function API_A from the invocation address LOC_A. This is indicated by arrow 202 to signify a transfer of control from the application.exe to the target function API_A within the kernel32 DLL. The first instruction of the target function API_A includes a transfer or jump instruction to the wrapper or stub function as described elsewhere herein. This transfer is indicated by arrow 204.

Within the pre-monitoring portion of the wrapper function, the intercepted call is verified. As used herein, the pre-monitoring code portion refers to that portion of code included in the wrapper or stub function executed prior to the execution of the body of the intercepted routine or function. Post-monitoring code refers to that code portion which is executed after the routine is executed.

The verification process of the pre-monitoring code may include examining the list of target and invocation locations 106 previously obtained during static analysis to verify that this call instance has been identified in the pre-processing step described elsewhere herein. In the event that the call is verified as being on the list 106, execution of the intercepted routine may proceed. Otherwise, the verified call processing code portion of the pre-monitoring portion may determine that this is an MC segment and may perform MC processing without executing the routine called.

A possible embodiment may identify the location of a call invocation by its return address. The return address is typically the next address following the call instruction, and can typically be found on the run-time stack at the time the call is intercepted. As part of verification processing done by the dynamic analyzer, an embodiment may use the return address to determine the location of the previous instruction and to verify that this instruction corresponds to, for example, a call or other expected instruction. It should be noted that in one possible embodiment, call locations may be defined as the locations that follow the call instructions, or as addresses of the instructions to which these calls are designed to return. The address of the location in this instance may be determined at run time by examining the return address included in the run time stack. Once determined, this location may be verified against the locations identified as part of static analysis.

It should also be noted that the pre-monitoring code may perform other types of verification. For example, additional verification processing may be performed in an embodiment. One embodiment may use additional static analysis information, such as parameter information associated with this call instance. Verifying the parameter information, including type and value of some parameters, may also be part of the call verification processing included in the pre-monitoring code.

Continuing with FIG. 7, after the call has been verified by the pre-monitoring code, the trampoline routine corresponding to API_A is invoked as indicated by arrow 206. The trampoline function executes previously saved instructions of API_A. The previously saved instructions were the first instructions of the routine API_A and were previously replaced with a jump instruction transferring control to the wrapper or stub function. Part of instrumenting DLLs in the embodiment includes dynamically modifying their memory loaded processes prior to this run time illustration 200 in which the instruction or instructions of the API of the target function are replaced with a jump instruction or other transfer instruction transferring control to the wrapper function. Prior to writing over the first instruction(s) of the target function, the first instruction(s) of the target function are copied or preserved in a save area which is included in the trampoline function. These first instructions are executed as part of the trampoline function after the pre-monitoring code has been executed and is indicated by the control transfer 206 to the trampoline function. Subsequently, control transfers back to the target function to continue execution of the target function body as indicated by arrow 208. When the target function has completed execution, control transfers to the wrapper function post-monitoring code as indicated by arrow 210. The post-monitoring code may be characterized as performing monitoring of the return of the target function. Additional verification and processing may be performed by the post-monitoring code, such as related to the return function value, other portions of the run time stack, function call chains, and the like. After post-monitoring code, the control transfers back 212 to the source function, to the location that follows location LOC_A from which function API_A was invoked.

FIG. 7 illustrates what happens at run time after instrumentation of the application and any associated libraries has been performed. What will now be described is one embodiment of the instrumentation process that happens prior to execution of the application, for example, as may be performed by the InstrumentSystemDLL routine included in the dynamic analyzer 108 previously described in connection with FIG. 5.

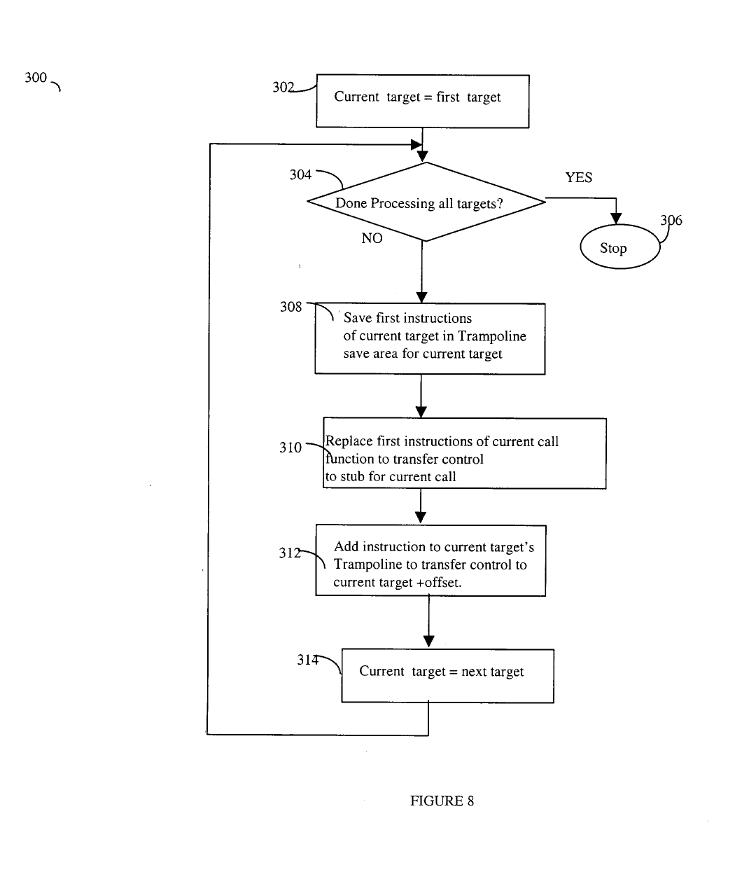

Referring now to FIG. 8, shown is the flowchart of steps of one embodiment that may be performed in connection with instrumenting the application and libraries dynamically when the application is loaded into memory with its libraries or DLLs. The steps described herein may be used in connection with instrumenting the binary form of the libraries that may be used by the application 102, all operating system libraries or DLLs, or any other set of libraries that may be determined as described elsewhere herein. These may optionally be stored in the list 112 of FIG. 4A. At step 302, a temporary variable, current target is assigned the first target routine. The processing described in flowchart 300 iterates over the list of targets included in the list 112 and performs processing in connection with each one until all of the targets have been processed. At step 304, a determination is made as to whether all of the targets have been processed. If so, control proceeds to step 306, where instrumentation stops. At step 304, if a determination is made that processing of all targets is not complete, control proceeds to step 308 where the first instruction(s) of the current target are stored in the trampoline save area associated with the current target. At step 310, the first instruction or instructions just saved from the current target are replaced by instructions which transfer control to the stub or wrapper for the current call. It should be noted that the number of instructions saved at step 308 may vary in accordance with the particular instruction representation, calling standard, and other factors of each particular embodiment. At step 312, another instruction is added to the current target trampoline, following the saved first instructions, which transfers control to the current target plus some offset values where the offset is the address of the next instruction following the one replaced at step 310. At step 314, the current target is advanced to the next target in the list 112 and processing continues until, at step 304, it is determined that all targets have been processed. It should be noted that steps 308 and 312 produce the trampoline function as described previously in connection with FIG. 7. Step 310 processing overwrites the first instruction(s) of the target API as loaded into memory of the application's user address space with a jump instruction. Step 310 processing causes a transfer of control to the wrapper function as represented by arrow 204 previously described in connection with FIG. 7.

The instrumentation processing described in connection with flowchart 300 may be performed, for example, by code included in the Detours package by Microsoft Research (http://research.microsoft.com/sn/detours/) which replaces the first few instructions of the target function with an unconditional jump to a user provided wrapper or stub function. Instructions from the target function may be preserved in the trampoline function as described herein. The trampoline function in this example includes: 1) instructions that are removed from the target function, and 2) an unconditional branch to the remainder of the target function.

It should be noted that as described herein, the code of the target function is modified in memory rather than on a storage device. This technique performs instrumentation of libraries as used by a one execution of an application while the original copies of the libraries are not modified. It should be noted as described herein, the trampolines may be created either statically or dynamically. Whether static or dynamic trampolines are used, for example, may vary in accordance with instrumentation tools used such as, for example, the Detours package which provides for use of static trampolines when the target function is available as the link symbol at link time. Otherwise, when the target function is not available at link time, a dynamic trampoline may be used with the Detours package. The Detours package provides for functionality that may be used in connection with creating both of these types of trampolines.

In the foregoing description, instrumentation may be selectively performed on those functions or routines an embodiment wishes to monitor at run time. For example, in the embodiment just described, all Win32 APIs and associated invocations are monitored. Every invocation of a Win32 API may be intercepted in the foregoing instrumentation technique. When one of the Win32 API calls is intercepted, this particular instance or invocation is checked against the list of previously obtained target and invocation locations 106 in order to see if the observed run time behavior matches that which is expected in connection with the previously performed static analysis.

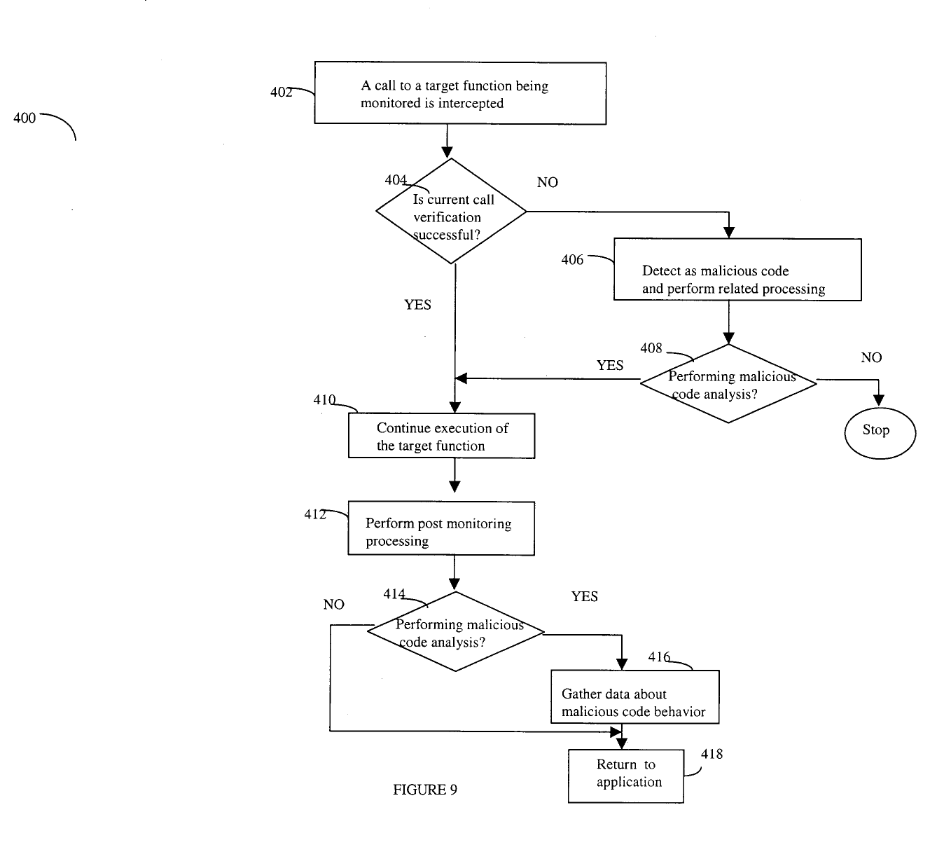

Referring now to FIG. 9, shown is a flowchart 400 of steps of one embodiment summarizing the run time processing previously described in connection with illustration 200 of FIG. 7. Flowchart 400 summarizes the processing steps that may be performed in an embodiment as part of dynamic analysis in connection with an MC detection system 100 during application execution. At step 402, a call to a target routine being monitored is intercepted. At step 404, a determination is made as to whether the current call verification is successful in connection with the current call being intercepted. As described elsewhere herein, this call verification may be performed by the pre-monitoring code within the stub or wrapper function associated with the current target routine. If it is determined that the call verification processing is successful, control proceeds to step 410 to continue execution of the target routine. Otherwise, if current call verification is not successful, control proceeds to step 406 where a determination is made that MC has been detected and related processing may be performed. Related processing may include, for example, obtaining run time information such as:
1) identifying the invocation location when the detection was made because the target function itself is not found on the list 106 produced by static analysis;
2) obtaining call-related information such as parameter information; and
3) obtaining additional run time information about the context of the invocation such as may be available in connection with a run time stack and other data structures that may vary with each embodiment.

The particular type of information that may be obtained and where it is stored may vary in accordance with each embodiment and is dependent on the system hardware and/or software.

At step 408, a determination is made as to whether MC analysis is being performed. In connection with an embodiment using the techniques described herein, MC detection as well as analysis may be performed. In other words, the pre-monitoring and post-monitoring code included in the wrapper or stub function may operate in a detection mode as well as an analysis mode. In the detection mode, the pre-monitoring and post-monitoring code may function as a detector which, upon detecting MC, such as with a failed call verification in the pre-monitoring code, may stop application execution and cause an error message and other processing steps to be taken. Upon detecting MC, an embodiment may return to the calling application with a return value corresponding to a function-specific error code. An embodiment may also signal a function-specific exception. Alternatively, the pre-monitoring and post-monitoring code may take into account that the software may run in a second mode as referred to herein as analysis mode. The MC analysis mode may be used, for example, by a security analyst to characterize or gain information about MC behavior. Accordingly, at step 408, if the pre-monitoring code determines that analysis is being performed, control may proceed to step 410 where the execution may continue with the target routine. In other words, the call made by MC is detected but is allowed to continue execution in order to gain further information about MC behavior.

At step 410, control is transferred to the target routine. Control is returned to the post-monitoring process at step 412, included in the wrapper or stub function as described elsewhere herein. At this point, determination is again made as to whether MC analysis is being performed, such as may be indicated by a boolean flag set by the pre-monitoring code or other technique. If so, additional data may be obtained about the MC behavior such as, for example, return values from the function just called and other types of run time information such as may be available from the stack or other run time context information. If MC analysis is not being performed, control may proceed by returning to the application at step 418.

It should be noted that an embodiment may perform MC detection alone, MC analysis alone, or include a switch which provides for switching between an MC detection mode and an MC analysis mode as described herein.

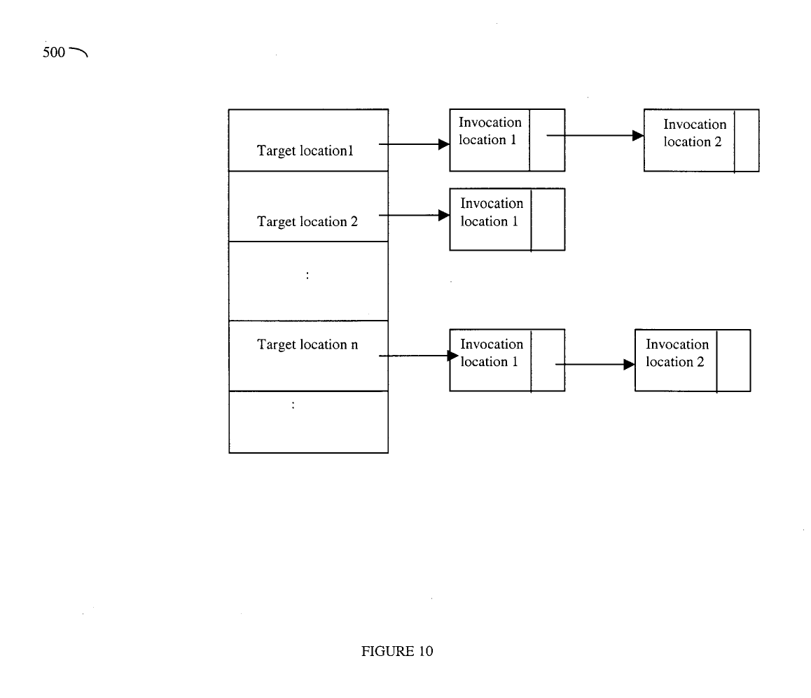

Referring now to FIG. 10, shown is an example of one embodiment of a data structure that may be used to store the target location and corresponding invocation location pairs 106. In this embodiment, the structure 500 includes an array of target locations. Each target location has an associated linked list of associated invocation locations. Since each target location may be invoked zero or more times, the associated linked list may have zero or more entries. The target locations may be stored in a sorted order, such as, for example, in sorted order based on symbol name of the associated API or target routine.

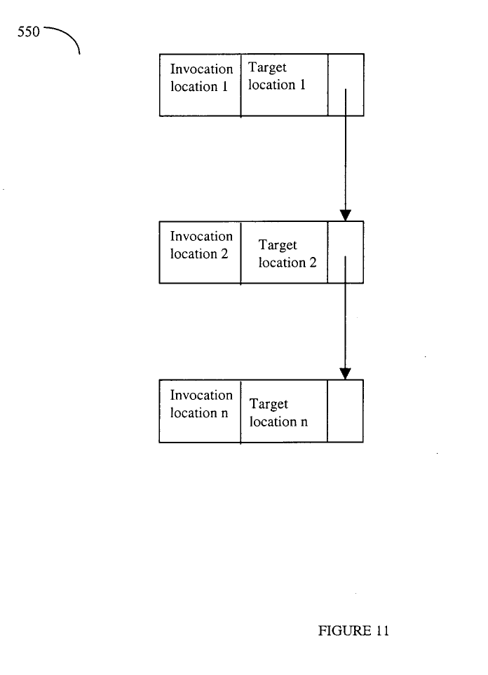

Referring now to FIG. 11, shown is an example of another embodiment of a data structure that may be used to store the target location and corresponding invocation location pairs 106. In this embodiment, the structure 550 includes a linked list of entries in which each entry corresponds to one of the target location and corresponding invocation location pairs. The entries may be stored in a sorted order, such as in order of increasing invocation locations in each programming or code segment.

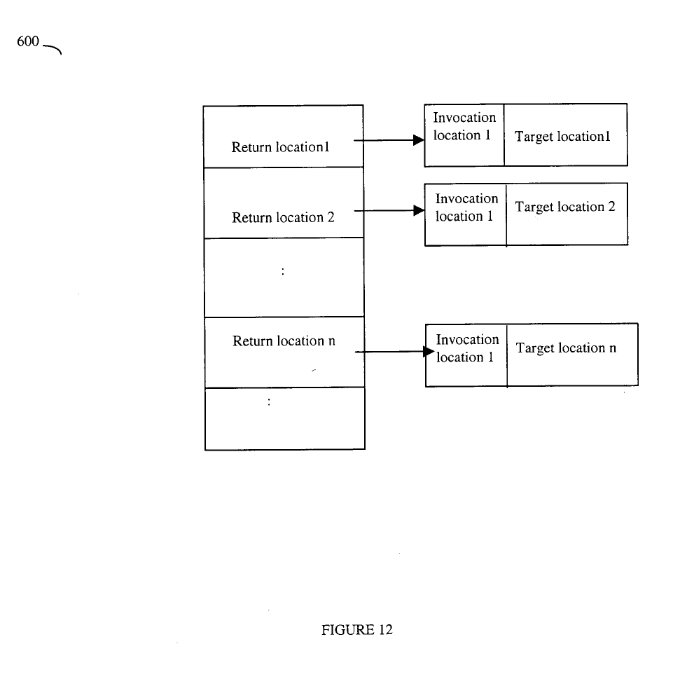

Referring now to FIG. 12, shown is an example of another embodiment of a data structure that may be used to store target location and corresponding invocation location pairs 106. In the data structure 600, each entry is stored in accordance with the return address, to which the target function returns after being called from the invocation location. In one embodiment, the return address is the location that follows the invocation location. Also, in one embodiment, this return address may be found at the top of the run time stack at the time an embodiment intercepts a call to the target function as described elsewhere herein. Using this return location, an embodiment may perform run time verification processing of the call as described elsewhere herein. An embodiment may also examine a copy of the application binary as stored on a data storage device and/or in memory, as well as use the information found on the run-time stack, heap, and other locations to perform verification processing.

It should be noted that the foregoing data structures of FIGS. 10, 11, and 12 are only representative data structures that may be included in an embodiment to store the information of the list 106 as described herein. Additionally, other static information, such as parameter information, may also be stored in this data structure or in another data structure(s). In one embodiment using one of the foregoing data structure 500, 550 or 600, the list 106 may be stored in memory when a localized version of the foregoing static analysis is dynamically performed in response to target function calls being intercepted. The data structures may also be optimized according to different considerations, such as their run-time performance and space characteristics.

An embodiment may store the results of static analysis in a file or other storage container. The data from the file or other storage container may be read, upon invocation of the application, and stored in memory in a data structure used, for example, when performing the call verification processing of the pre-monitoring code described herein. The data from the file may be read for each of multiple invocation instances of the application.

The static analysis data processing may be performed, for example, using automated and/or manual techniques when there are modifications to the application such as may result from recompilation and relinking.

It should be noted that the application may involve multiple executable components. For example, an application may make calls to system libraries as well as customized libraries of routines developed for use with a particular application. One embodiment may be designed to handle such applications. Additionally, an embodiment may handle DLL relocation issues, which may occur when, for example, two or more DLLs want to be loaded into the same process address range. This may be done by using locations that are relative to the base addresses of the DLLs. The particular details releated to these issues may vary with each embodiment.

In one embodiment, each target location and invocation location may be represented by a symbolic name and/or offset that may vary in accordance with how each may be represented in an embodiment. For example, the invocation location may be represented by an offset within the invoking module or routine. The target location may be represented by a symbolic name and offset where the symbolic name corresponds to the name of the target function or routine being invoked. In one embodiment, when the target functions are external, this symbolic name may be included in an imported symbol table of the application being invoked. The imported symbol table may also include the address of the externally defined function.

The foregoing techniques may be used in connection with the detection tool to monitor executions of applications included in various directories. The foregoing detection techniques may also monitor the run time behavior of only particular applications. The application may be executed, and also have MC detection and/or analysis performed, as a result of a normal user invocation in performing an operation. For example, a user may be executing a word processing application in connection with editing a document and MC detection and/or analysis may be performed.

It should also be noted that in connection with using the foregoing techniques as a detection tool, the detection tool may run as a background process, for example, scanning a file system for different executables that may be stored on particular devices or located in particular directories within the system. The detection tool may execute, for example, as a background task, use the foregoing techniques and invoke and execute one or more of the executables in order to possibly detect MC contained in these executables. This may also be done as an emulation or simulation of the execution, or in what is known to those skilled in the art as a virtual environment, such as VMWare.

An application may be executed using the techniques described herein at a variety of different times. The application may be executed during normal usage, when purposefully testing it for the presence of MC, or when analyzing the MC embedded within the application. An execution of the application may also be emulated or simulated.

Any one of a variety of different techniques such as described herein may be used in connection with obtaining a list of particular target routines whose invocations are to be monitored 112 An entire file system, or libraries located in a certain disk location, directory, and the like, may be pre-processed to obtain a list of routines or functions to be monitored. Particular routines or functions to be monitored may also be obtained by observing those that are actually being invoked when applications execute. These may include particular system routines, such as what Win32 APIs. The list of routines monitored may be a superset of those invoked by applications and the foregoing may be used in the determination of what to include in the list 112. The foregoing techniques may also be used in determining which DLLs may be instrumented as part of a preprocessing step prior to executing the application. Similarly, the foregoing techniques may be used in determining which routines to include in the list of target functions whose invocations are to be identified by static analysis 111.

It should be noted that the foregoing techniques are applied in particular to binary machine executable codes. However, the foregoing techniques may be characterized as extensible and generally applicable for use with any one of a variety of different types of binary and machine-executable programs, as well as script programs, command program, and the like. The foregoing techniques may be used and applied in connection with detecting and analyzing calls to target functions or services made by MC from programs in which control is transferred from one point to another. Such a program can be analyzed using static analysis to create a model comprised of the identified calls, their locations within the program, and other call-related information. Then, the executions of the forgoing program can be monitored to intercept the calls to target functions and services occurring at run-time and to verify that these calls, the locations from which they occur, and other call-related information match those identified by static analysis. Implementing the monitoring and interception steps may involve the instrumentation of the program itself and/or the program's processor or interpreter. In case of a bytecode program, a program processor may be what is known in the art as a “virtual machine”; in case of a script or command program, the program processor may be referred to, respectively, as a “script processor” or “command processor”.

In connection with the binary code, the foregoing techniques may be used in connection with detecting MC where the MC is characterized as injected code by detecting calls from invocation locations not previously identified during the static analysis phase. The foregoing techniques may be used in connection with detecting MC for dynamically generated embedded MC because there is a difference between the binary code that was analyzed prior to execution and the binary code which is executed. Dynamically generated embedded MC that is executed may be the result of a mutated or modified form of the binary code analyzed prior to execution. In connection with MC detection of obfuscated MC, the target address, for example, may be a run time computed address to a target location whose location has not been identified prior to execution. As another example, obfuscated MC may, for example, perform string manipulation to form a name of an API or a target routine which, again, may not be identified by the static analysis described herein. Simple MC may be detected by the foregoing techniques if the MC is embedded into an application's code after the pre-processing step of static analysis has been performed. In such situations, the simple MC may include invocations to APIs from the locations that were not identified by static analysis. Accordingly, in such situations, the foregoing techniques would detect the simple MC. It should be noted that using the foregoing technique to detect simple MC that is embedded into the application after it has been statically analyzed has its limitations and shortcomings. On the other hand, detecting unauthorized modifications, including those by simple MC, to the application after it has been statically analyzed can be accomplished by simpler and more efficient techniques, such as by hashing the application files using the MD5 hash functions, as used by Tripwire. An embodiment may use such techniques.

The foregoing technique works because most non-malicious applications do not generate or inject code at run-time, nor do they obfuscate it. Those that do are limited to particular types of non-malicious code and the foregoing technique can be tailored in a variety of ways to deal with these. For example, legitimate uses of obfuscation and dynamic code generation can be cleared in advance per application either locally per installation by application user or a system administrator, or globally by software manufacturer, a trusted third-party, or a site administrator, or by any other means. This would result in including the locations from which the legitimately obfuscated or dynamically generated calls are made into the model. In addition, the technique can be made to recognize and handle certain legitimate uses of dynamic code generation, such as in stack trampolines, which facilitate the use of nested functions; just-in-time compilers, which create native machine code from byte-code; and executable decompressors, which at run time decompress previously compressed executable code loaded from disk.

The foregoing techniques may be used in connection with creation of tools to assist analysts in dissecting and understanding different types of MCs. Currently, analysts may use general purpose dissemblers and debuggers for this purpose. The foregoing techniques may be used, as an alternative or in addition to existing techniques and tools, in reducing the time-frame required to understand and gather information about a particular portion of MC since the foregoing techniques, for example, may be used in identifying the exact portions of a particular executable that are malicious as well as gathering run time context information about the execution of the MC. For example, the foregoing may be used in obtaining a run time trace of the dynamic call chain associated with MC.

It should be noted that although the foregoing description instruments libraries, such as DLLs, other bodies of code, such as different types of libraries (memory loaded, rom- or flash-resident, and disk), shared objects, and even the application or other customized routine used by the particular application, may also be instrumented and used in connection with the techniques described herein.

While the invention has been disclosed in connection with preferred embodiments shown and described in detail, their modifications and improvements thereon will become readily apparent to those skilled in the art. Accordingly, the spirit and scope of the present invention should be limited only by the following claims.

1. A method for detecting malicious code comprising:
performing static analysis of an application prior to execution of the application identifying any invocations of at least one predetermined target routine;
determining, prior to executing said at least one predetermined target routine during execution of the application, whether a run time invocation of the at least one predetermined target routine has been identified by said static analysis as being invoked from a predetermined location in said application; and
if the run time invocation of the at least one predetermined target routine has not been identified from a predetermined location by said static analysis, determining that the application includes malicious code.

2. The method of claim 1, wherein said target routines are external to the said application, and the method further comprising:
instrumenting a binary form of a library such that all invocations of a predetermined set of one or more external routines included in said library are intercepted; and
intercepting an invocation instance of one of said external routines.

3. The method of claim 2, wherein said predetermined set includes a portion of system functions.

4. The method of claim 1, further comprising, performing, prior to executing said application:
determining an invocation location within said application from which a call to said at least one predetermined target routine is made; and
determining a target location associated with said invocation location, said target location corresponding to said at least one predetermined target routine to which said call is being made.

5. The method of claim 4, further comprising:
using said invocation location and said associated target location to determine, during execution of said application, whether an intercepted call to target routine has been identified by said static analysis.

6. The method of claim 1, wherein static analysis is performed after beginning execution of instructions of said application and prior to execution of said at least one predetermined routine.

7. The method of claim 1, wherein said static analysis is performed as a preprocessing step prior to at least one of: invoking said application and executing a first instruction of said application.

8. The method of claim 7, wherein a single static analysis is performed producing static analysis results used in connection with a plurality of subsequent executions of said application.

9. The method of claim 1, wherein said target routines are external to the said application, further comprising:
loading said application into memory such that said application is in a suspended execution state;
instrumenting a library used by said application such that invocations of a predetermined set of one or more external routines defined in said library are intercepted; and
executing said application and intercepting an invocation instance of one of said predetermined set of external routines.

10. The method of claim 1 further comprising:
prior to executing a target routine, intercepting a call to the target routine and verifying that the call to the target routine has been identified by said static analysis.

11. The method of claim 10, further comprising:
intercepting control after completing execution of said target routine.

12. The method of claim 10, further comprising:
determining that the application includes malicious code.

13. The method of claim 12, further comprising:
halting execution of said application upon determining that said application includes malicious code.

14. The method of claim 11, further comprising:
determining that the application includes malicious code;
determining if malicious code analysis is being performed;
if malicious code analysis is being performed:
executing the intercepted target routine that failed verification; and
intercepting control after said target routine has completed executing.

15. The method of claim 5, wherein said static analysis includes obtaining parameter information associated with target routine calls made from said application, and the method comprising:
using said parameter information in verifying an intercepted target routine call by comparing said parameter information of said static analysis to other parameter information of said intercepted target routine call wherein said verifying is used in determining whether said application includes malicious code.

16. The method of claim 1, further comprising:
determining which target routines are executed by one or more other applications; and
intercepting any invocations of said target routines during execution of said application.

17. The method of claim 9, wherein further comprising, performing after said loading prior to executing said application:
copying, for each of said one or more external routines, a first set of one or more instructions to a save area corresponding to said each external routine; and
modifying a memory copy of each of said one or more external routines to transfer control to a wrapper routine corresponding to said each external routine prior to executing any instructions of said each external routine and after all instructions of said each external routine have been executed.

18. The method of claim 10, further comprising:
obtaining run time context information about said target routine including at least one of: run time call chain information before executing an intercepted target routine, run time call chain information after executing an intercepted target routine, run time stack information, and return parameter information.

19. The method of claim 12, further comprising, if malicious code analysis is not being performed, performing at least one of the following: returning a return value corresponding to a predetermined error code, and transferring run time control to routine-specific condition handler.

20. The method of claim 2, wherein said instrumentation is performed as a preprocessing step prior to executing an instruction of said application.

21. The method of claim 2, wherein said instrumentation is performed dynamically after beginning execution of instructions of said application.

22. The method of claim 2, wherein said instrumenting produces an instrumented version of said binary form and said instrumented version is stored on a storage device.

23. The method of claim 2, wherein said instrumenting produces an instrumented version of said binary form and said instrumented version is stored in memory.

24. The method of claim 5, further comprising, for determining said invocation location:
obtaining a return address from a run time stack, said return address identifying an address of said application to which control is returned after completion of a call to a target routine;
using said return address to determine another location in said application of a previous instruction immediately prior to said return address;
determining whether contents of said other location includes an expected transfer instruction; and
if said contents does not include an expected transfer instruction, determining that said application includes malicious code.

25. The method of claim 24, further comprising:
determining, using information obtained from static analysis of said application, whether other locations of said application include at least one element of expected information associated with the expected transfer instruction; and
if said contents does not include said at least one element of expected information, determining that said application includes malicious code.

26. The method of claim 24, wherein said information of said other location is obtained from a copy of said application stored on a storage device.

27. The method of claim 24, wherein said information of said other location is obtained from a copy of said application stored in a memory.

28. The method of claim 1, wherein said application is one of: bytecode form, script language form, and command language form, and the method further comprises:
instrumenting one of: a processor of said application and said application such that all invocations of a predetermined set of one or more target routines invoked by said application are intercepted; and
intercepting an invocation instance of one of said target routines.

29. The method of claim 14, further comprising, if malicious code analysis is being performed:
obtaining run time context information about said malicious code including at least one of: return parameter information, run time call chain information before executing an intercepted target routine, run-time chain after executing an intercepted target routine and run time stack information.

30. The method of claim 7, wherein the results of said static analysis are stored on at least one of: a storage device and a memory.

31. The method of claim 1, wherein the said static analysis is performed on a host on which the application is executed.

32. The method of claim 1, wherein said static analysis is performed on a first host and static analysis results are made available to a second host on which said application is executed.

33. The method of claim 1, wherein the results of said static analysis are distributed together with the said application.

34. The method of claim 1, wherein said target routines are external to the said application, and the method further comprising:
using an instrumented version of a binary form of a library such that all invocations of a predetermined set of one or more external routines included in said library are intercepted; and
intercepting an invocation instance of one of said external routines.

35. The method of claim 34, wherein said instrumented version of said binary form obtained from at least one of: a data storage system and a host other than a host on which said application is executed, and said instrumented version is stored on a storage device.

36. A method for detecting malicious code comprising:
determining, prior to executing at least one predetermined target routine during execution of the application, whether a run time invocation of the at least one predetermined target routine is identified by a model as being invoked from a predetermined location in said application, said model identifying locations within said application from which invocations of the at least one predetermined target routine occur; and
if the run time invocation of the at least one predetermined target routine has not been identified from a predetermined location by said model, determining that the application includes malicious code.

37. A method for detecting malicious code comprising:
obtaining static analysis information of an application identifying any invocations of at least one predetermined target routine;
determining, prior to executing said at least one predetermined target routine during execution of the application, whether a run time invocation of the at least one predetermined target routine has been identified by said static analysis information as being invoked from a predetermined location in said application; and
if the run time invocation of the at least one predetermined target routine has not been identified from a predetermined location by said static analysis information, determining that the application includes malicious code.

38. A computer program product that detects malicious code comprising:
executable code that performs static analysis of an application prior to execution of the application identifying any invocations of at least one predetermined target routine;
executable code that determines, prior to executing said at least one predetermined target routine during execution of the application, whether a run time invocation of the at least one predetermined target routine has been identified by said static analysis as being invoked from a predetermined location in said application; and
executable code that, if the run time invocation of the at least one predetermined target routine has not been identified from a predetermined location by said static analysis, determines that the application includes malicious code.

39. The computer program product of claim 38, wherein said target routines are external to the said application, the computer program product further comprising:
executable code that instruments a binary form of a library such that all invocations of a predetermined set of one or more external routines included in said library are intercepted; and
executable code that intercepts an invocation instance of one of said external routines.

40. The computer program product of claim 39, wherein said predetermined set includes a portion of system functions.

41. The computer program product of claim 38, further comprising, executable code that, prior to executing said application:
determines an invocation location within said application from which a call to said at least one predetermined target routine is made; and
determines a target location associated with said invocation location, said target location corresponding to said at least one predetermined target routine to which said call is being made.

42. The computer program product of claim 41, further comprising:
executable code that uses said invocation location and said associated target location to determine, during execution of said application, whether an intercepted call to target routine has been identified by said static analysis.

43. The computer program product of claim 38, wherein static analysis is performed after beginning execution of instructions of said application and prior to execution of said at least one predetermined routine.

44. The computer program product of claim 38, wherein said static analysis is performed as a preprocessing step prior to at least one of: invoking said application and executing a first instruction of said application.

45. The computer program product of claim 44, wherein a single static analysis is performed producing static analysis results used in connection with a plurality of subsequent executions of said application.

46. The computer program product of claim 38, wherein said target routines are external to the said application, the computer program product further comprising:
executable code that loads said application into memory such that said application is in a suspended execution state;
executable code that instruments a library used by said application such that invocations of a predetermined set of one or more external routines defined in said library are intercepted; and
executable code that executes said application and intercepting an invocation instance of one of said predetermined set of external routines.

47. The computer program product of claim 38, further comprising:
executable code that, prior to executing a target routine, intercepts a call to the target routine and verifies that the call to the target routine has been identified by said static analysis.

48. The computer program product of claim 47, further comprising:
executable code that intercepts control after completing execution of said target routine.

49. The computer program product of claim 47, further comprising:
executable code that determines that the application includes malicious code.

50. The computer program product of claim 49, further comprising:
executable code that halts execution of said application upon determining that said application includes malicious code.

51. The computer program product of claim 48, further comprising:
executable code that determines that the application includes malicious code;
executable code that determines if malicious code analysis is being performed;
executable code that, if malicious code analysis is being performed:
executes the intercepted target routine that failed verification; and
intercepts control after said target routine has completed executing.

52. The computer program product of claim 42, wherein said static analysis includes obtaining parameter information associated with target routine calls made from said application, and the computer program product comprising:
executable code that uses said parameter information in verifying an intercepted target routine call by comparing said parameter information of said static analysis to other parameter information of said intercepted target routine call wherein said verifying is used in determining whether said application includes malicious code.

53. The computer program product of claim 38, further comprising:
executable code that determines which target routines are executed by one or more other applications; and
executable code that intercepts any invocations of said target routines during execution of said application.

54. The computer program product of claim 46, further comprising executable code that, after said loading prior to executing said application:
copies, for each of said one or more external routines, a first set of one or more instructions to a save area corresponding to said each external routine; and
modifies a memory copy of each of said one or more external routines to transfer control to a wrapper routine corresponding to said each external routine prior to executing any instructions of said each external routine and after all instructions of said each external routine have been executed.

55. The computer program product of claim 47, further comprising:
executable code that obtains run time context information about said target routine including at least one of: run time call chain information before executing an intercepted target routine, run time call chain information after executing an intercepted target routine, run time stack information, and return parameter information.

56. The computer program product of claim 49, further comprising, if malicious code analysis is not being performed, performing at least one of the following: returning a return value corresponding to a predetermined error code, and transferring run time control to routine-specific condition handler.

57. The computer program product of claim 39, wherein said executable code that instruments is executed as a preprocessing step prior to executing an instruction of said application.

58. The computer program product of claim 39, wherein said executable code that instruments is executed so that instrumentation is dynamically performed after beginning execution of instructions of said application.

59. The computer program product of claim 39, wherein said executable code that instruments produces an instrumented version of said binary form and said instrumented version is stored on a storage device.

60. The computer program product of claim 39, wherein said executable code that instruments produces an instrumented version of said binary form and said instrumented version is stored in memory.

61. The computer program product of claim 42, wherein said executable code that determines said invocation location, further comprises executable code that:
obtains a return address from a run time stack, said return address identifying an address of said application to which control is returned after completion of a call to a target routine;
uses said return address to determine another location in said application of a previous instruction immediately prior to said return address;
determines whether contents of said other location includes an expected transfer instruction; and
if said contents does not include an expected transfer instruction, determines that said application includes malicious code.

62. The computer program product of claim 61, further comprising:
executable code that determines, using information obtained from static analysis of said application, whether other locations of said application include at least one element of expected information associated with the expected transfer instruction; and
executable code that, if said contents does not include said at least one element of expected information, determines that said application includes malicious code.

63. The computer program product of claim 61, wherein said information of said other location is obtained from a copy of said application stored on a storage device.

64. The computer program product of claim 61, wherein said information of said other location is obtained from a copy of said application stored in a memory.

65. The computer program product of claim 38, wherein said application is one of: bytecode form, script language form, or command language form, and the computer program product further comprises:
executable code that instruments one of: a processor of said application and said application such that all invocations of a predetermined set of one or more target routines invoked by said application are intercepted; and
executable code that intercepts an invocation instance of one of said target routines.

66. The computer program product of claim 51, further comprising, executable code that, if malicious code analysis is being performed:
obtains run time context information about said malicious code including at least one of: return parameter information, run time call chain information before executing an intercepted target routine, run-time chain after executing an intercepted target routine and run time stack information.

67. The computer program product of claim 44, further comprising executable code that stores the results of static analysis on at least one of: a storage device and a memory.

68. The computer program product of claim 38, wherein the said executable code that performs static analysis is executed on a host on which the application is executed.

69. The computer program product of claim 38, wherein said executable code that performs static analysis is executed on a first host and the computer program product further includes executable code that makes static analysis results available to a second host on which said application is executed.

70. The computer program product of claim 38, wherein the results of said static analysis are distributed together with the said application.

71. The computer program product of claim 38, wherein said target routines are external to the said application, and the computer program product further comprising:
executable code that uses an instrumented version of a binary form of a library such that all invocations of a predetermined set of one or more external routines included in said library are intercepted; and
executable code that intercepts an invocation instance of one of said external routines.

72. The computer program product of claim 71, wherein said instrumented version of said binary form obtained from at least one of: a data storage system and a host other than a host on which said application is executed, and said instrumented version is stored on a storage device.

73. A computer program product that detects malicious code comprising:
executable code that determines, prior to executing at least one predetermined target routine during execution of the application, whether a run time invocation of the at least one predetermined target routine is identified by a model as being invoked from a predetermined location in said application, said model identifying locations within said application from which invocations of the at least one predetermined target routine occur; and
executable code that, if the run time invocation of the at least one predetermined target routine has not been identified from a predetermined location by said model, determines that the application includes malicious code.

74. A computer program product that detects malicious code comprising:
executable code that obtains static analysis information of an application identifying any invocations of at least one predetermined target routine;
executable code that determines, prior to executing said at least one predetermined target routine during execution of the application, whether a run time invocation of the at least one predetermined target routine has been identified by said static analysis information as being invoked from a predetermined location in said application; and
executable code that, if the run time invocation of the at least one predetermined target routine has not been identified from a predetermined location by said static analysis information, determines that the application includes malicious code.
